(19) United States
(12) Patent Application Publication
(10) Pub. No.: US 2026/0126655 A1
(43) Pub. Date: May 7, 2026

(54) EFFICIENT LED ILLUMINATION OPTICS FOR LCOS DISPLAY

(71) Applicant: GOOGLE LLC, Mountain View, CA (US)

(72) Inventors: Nam-Hyong Kim, San Jose, CA (US); Yi Qin, Mountain View, CA (US); Dmitriy Churin, Mountain View, CA (US); Thomas Hoekman, Redwood City, CA (US)

(21) Appl. No.: 19/376,166

(22) Filed: Oct. 31, 2025

Related U.S. Application Data
(60) Provisional application No. 63/715,268, filed on Nov. 1, 2024.

(51) Int. Cl. G02B 27/01; G02B 5/04; G02B 19/00; G02B 27/28

(52) U.S. Cl. CPC G02B 27/0172; G02B 5/04; G02B 19/0009; G02B 19/0066; G02B 27/286

(57) ABSTRACT

Techniques are provided for recycling polarization and managing color within a compact optical illumination architecture. An LED array is segmented by color channels and coupled to a condenser lens array to collimate and homogenize irradiance. A polarization-recycling prism includes internal polarization interfaces and dichroic coatings configured for complementary spectral routing across wavelength bands. A polarization assembly, disposed within or adjacent to the prism and including a retarder plate and reflector, is utilized to convert light reflected in a first polarization state to a second polarization state for transmission through the prism.

### BACKGROUND

Liquid Crystal on Silicon (LCOS) technology is widely used in compact display systems, especially for augmented reality (AR) and near-eye displays (NEDs). LCOS displays typically utilize linearly polarized light. However, most LED sources emit unpolarized light, wasting about half of the emitted light unless polarization recycling techniques are employed. Previous approaches have addressed this issue by using components that add significant size and complexity, limiting efficiency gains and making the systems less suited to compact AR applications. Other approaches attempt to improve polarization efficiency using modified LED arrangements, but typically offer limited gains and introduce further design challenges in color uniformity and optical alignment. There remains a need for an efficient, compact LCOS illumination system that achieves effective polarization recycling without increasing system bulk or sacrificing visual quality.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates a light polarization conversion system.

FIG. 2 illustrates red and green/blue recycling and wavelength-selective illumination paths through a polarization-recycling prism, in accordance with certain embodiments.

FIG. 3 illustrates an optical layout of a high-efficiency LCOS microprojector system incorporating polarization recycling, in accordance with certain embodiments.

FIG. 4 illustrates an alternative optical pathway configuration for polarization recycling in a projection system, in accordance with some embodiments.

FIG. 5 illustrates complementary red and green/blue routing within a polarization-recycling prism, in accordance with some embodiments.

FIG. 6 illustrates a projection system implementing polarization recycling with wavelength-selective dichroic layers, in accordance with some embodiments.

FIG. 7 illustrates a spectral graph depicting an intensity distribution across wavelengths for blue, green, and red LED segments in a projection system with polarization recycling, in accordance with some embodiments.

FIG. 8 illustrates an LED segment array and condenser lens array configuration designed to generate an asymmetric irradiance profile at the exit pupil of an LCOS microprojector, in accordance with certain embodiments.

FIGS. 9, 10, and 11 illustrate non-limiting examples of specific LED array configurations, in accordance with some embodiments.

FIG. 12 is an operational flow diagram illustrating a method of operating an illumination module configured for polarization recycling, in accordance with some embodiments.

### DETAILED DESCRIPTION

As used herein, étendue refers to a measure of the spread of light in an optical system, encompassing both the area of the light source and the range of angles over which the light is emitted. In the context of illumination systems, desirably decreasing or constraining étendue typically constrains the light collection efficiency and physical size of a system using passive optical elements. A higher étendue often necessitates larger optics or limits the degree of collimation achievable, impacting the system's overall efficiency and form factor.

The embodiments described herein aim to manage and effectively utilize étendue in a way that improves the efficiency of display projection systems (such as LCOS illumination systems) without unnecessarily increasing the incorporating system's physical size. By utilizing polarization recycling and color homogenization techniques within a single optical element, the described embodiments maintain the étendue of the light emitted from a segmented LED array without increasing it.

In particular, embodiments of techniques described herein utilize an LED illumination system segmented into an array of segments, with each segment corresponding to one of multiple spatially separated color channels. In certain embodiments, each LED segment is coupled to a condenser lens configured to collimate emitted light. A polarization-recycling prism is optically coupled to the condenser lens; the prism includes an internal interface configured to transmit a second polarization state and reflect a first polarization state toward an optical polarization assembly. As used herein, an optical polarization assembly (also referred to as a polarization assembly) refers to a reflector used in combination with at least one retarder plate (e.g., a quarter-and/or half-wave plate) and in certain embodiments is configured to convert light reflected by an internal interface of a polarization-recycling prism from a first polarization state to a second polarization state. The polarization assembly is positioned to receive the reflected light and to convert it to the second polarization state for return to the internal interface. In various embodiments, one or more internal surfaces of the polarization-recycling prism carry dichroic coatings configured, in combination, to route wavelengths corresponding to other LED segments so that color channels are managed within the prism. In such embodiments, respective internal surfaces include coatings tailored to the associated LED segments, thereby enhancing both polarization and color uniformity.

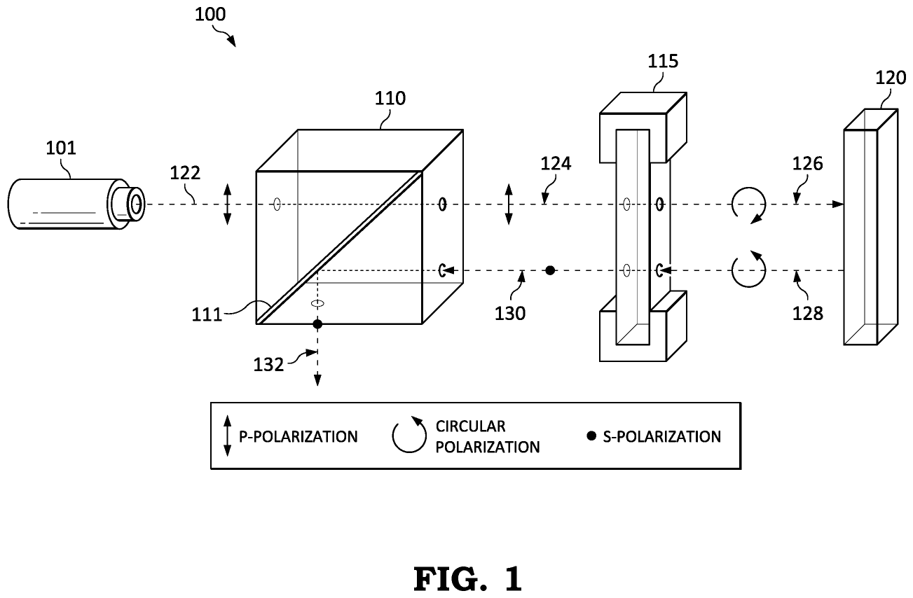

FIG. 1 illustrates a polarization conversion system 100. A source 101 emits a linearly P-polarized light beam 122 that propagates to a polarization-recycling prism 110 that includes an internal interface 111. Because the internal interface 111 of the polarization-recycling prism 110 is configured to transmit P-polarized light, the beam passes substantially unaffected on an initial trip through the polarization-recycling prism 110 and is shown at position 124 with the same P polarization. The beam 122 then propagates through a quarter-wave plate 115, which converts the linear state of P polarization to circular polarization; at position 126 the beam is thereby circularly polarized with clockwise handedness. The beam reflects from a reflecting surface (reflector) 120, which reverses the handedness of the circular state, such that at position 128 the beam is circularly polarized with counterclockwise handedness while propagating back toward the quarter-wave plate 115. On the return through the quarter-wave plate 115, the circular state is converted to the orthogonal linear state, yielding S polarization at position 130. Re-entering the polarization-recycling prism 110 in the S-polarized state, the beam is reflected by the internal interface 111 of the polarization-recycling prism 110 and exits along a path orthogonal to the original direction, indicated at position 132.

It will be appreciated that the identification of the transmitted beam as P-polarized and the reflected beam as S-polarized is merely for ease of illustration; in other configurations, depending on the orientation and design (such as via one or more coatings and/or angular placement for interface 111) of the polarization-recycling prism 110, the beamsplitting internal interface 111 may be configured such that the transmitted and reflected polarizations are reversed while the sequence of polarization transformations remains as described.

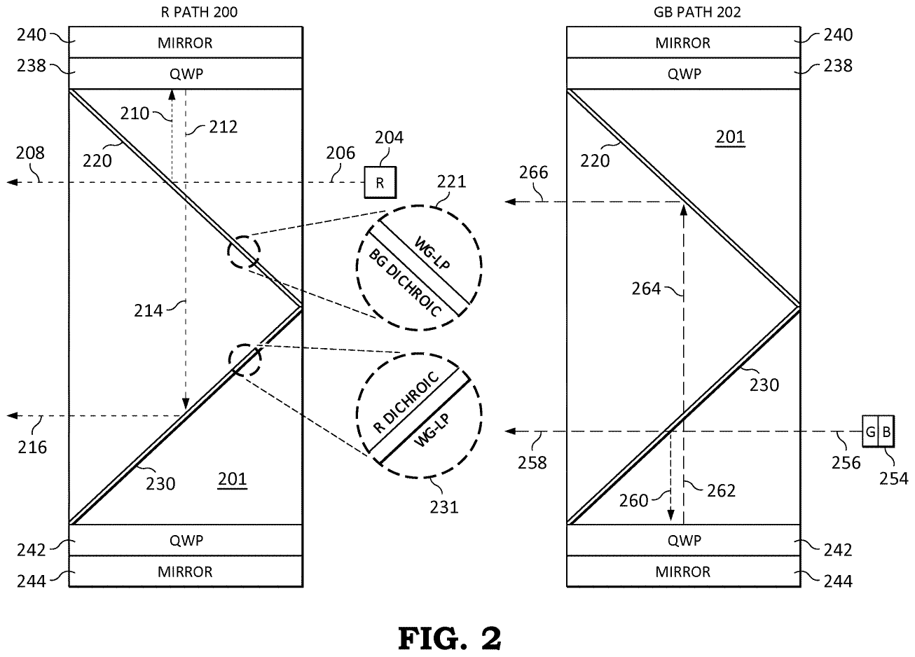

FIG. 2 illustrates red and green/blue illumination paths (in complementary panels 200, 202) through a polarization-recycling prism 201, in accordance with certain embodiments. The polarization-recycling prism 201 is shown on both sides of the figure for ease of illustration and to indicate that the prism body of the polarization-recycling prism 210 and its coated internal interfaces 220 and 230 are reused for both spectral ranges. On the red side (left panel 200), a red source 204 emits a beam 206 into the polarization-recycling prism 201. At the first coated interface 220, the coatings 221 are configured such that a red component 208 is transmitted through coated internal interface 220 while a red component 210 is reflected off the coated internal interface 220 toward an optical polarization assembly that includes a quarter-wave plate (QWP) 238 and a reflector 240. After a double pass through the QWP 238 and reflection from the reflector 240, the returned red component 212 re-enters the prism 201 with a polarization state converted to be transmitted at the interface 220, thereby propagating red component 214 inside the prism 201. The red component 214 then impinges on the second coated internal interface 230 where, for red wavelengths, the coatings 231 are configured to reflect the beam, producing component 216 directed along the illustrated exit direction toward downstream optics.

On the green/blue side (right panel 202), a GB source 254 emits a beam 256 into the same prism 201 from the opposite end. For these wavelengths, the coatings 231 at interface 230 are configured so that a GB component 258 is transmitted through the coated internal interface 230 while a GB component 260 is reflected off the coated internal interface 230 toward a polarization assembly that includes a quarter-wave plate 242 and a reflector 244. After double pass through the QWP 242 and reflection from the reflector 244, the returned GB component 262 re-enters the prism 201 with a polarization state converted to be transmitted at the coated internal interface 230, yielding a propagated component 264 inside the prism 201. The GB path then reaches the coated internal interface 220 where, for GB wavelengths, the coatings 221 are configured to reflect, producing component 266 directed along the indicated exit direction.

As depicted, the coated internal interfaces 220 and 230 together with coatings 221 and 231 are configured to provide complementary spectral routing while the quarter-wave plates 238 and 242 and reflectors 240 and 244 convert and return the reflected polarization components so that, for each spectral band, the light that continues through the prism 201 emerges with a common linear polarization suitable for illumination of downstream modulation optics.

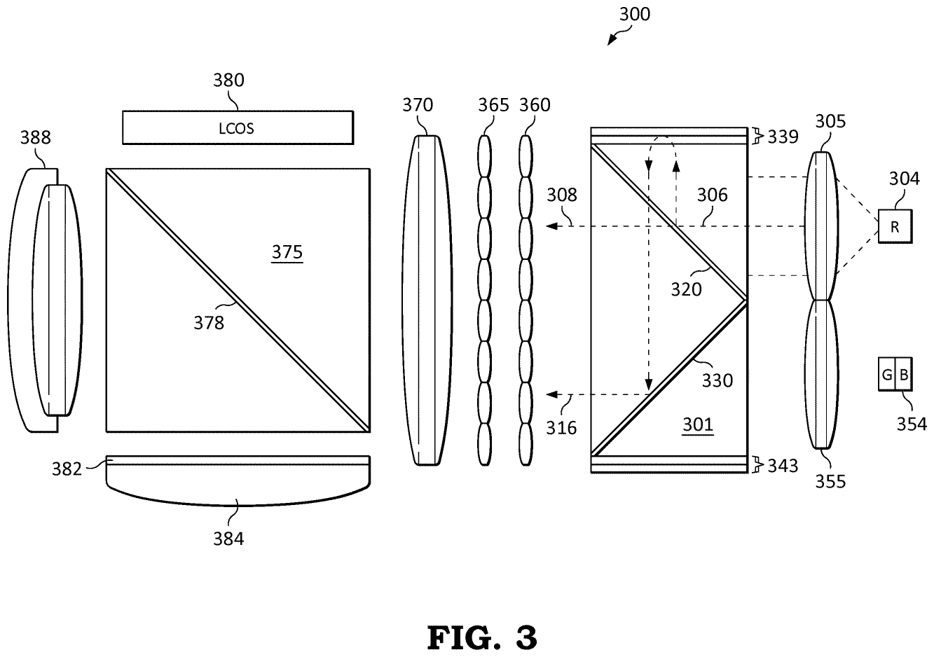

FIG. 3 illustrates an optical layout of a high-efficiency LCOS microprojector system 300 incorporating polarization recycling and color homogenization elements, in accordance with certain embodiments.

In the depicted embodiment, a collimating lens 305 collimates light beams emitted by a red light source 304 to form a red beam 306, which is directed into a coated prism forming the body of polarization-recycling prism 301 with internal interfaces 320 and 330. At interface 320, the coatings are configured such that a first red component 308 is transmitted through the interface 320, while the remaining component of beam 306 reflects off of the interface 320 towards an upper optical polarization assembly 339, which includes a quarter-wave plate and reflector in a manner similar to that described for elements 238, 240 and 242, 244 of FIG. 2. The reflected component 306 passes through the quarter-wave plate of the upper polarization assembly 339, reflects from the reflector of the upper polarization assembly 339, and returns through the quarter-wave plate again to convert to the pass polarization at interface 320; the polarization-converted light passes back through the interface 320 as beam 316 and is redirected via interface 330, where it reflects as shown to co-propagate toward the left with the transmitted component beam 308.

In various embodiments, the two red components 308, 316 emerging from the polarization-recycling prism 301 share a common linear polarization suitable for efficiently illuminating a reflective modulator. A GB source 354 with a collimating lens 355 is positioned to emit a GB beam along a complementary path (not drawn for clarity and brevity) utilizing a lower polarization assembly 343 and coatings at the same interfaces 320 and 330 to transmit and reflect GB wavelengths in a manner similar to that described with respect to FIG. 2.

Downstream of the polarization-recycling prism 301, the illumination provided by the beams 308, 316 is conditioned by a condenser lens array 360, an integrator/relay element 365, and a condenser lens 370 configured to homogenize irradiance and shape the exit pupil. The resulting conditioned beam is delivered to a polarization beam splitter 375 with internal interface 378, both positioned to illuminate a reflective spatial light modulator (e.g., an LCOS display panel) 380. A retarder 382 and a fold reflector 384 are arranged to form an optical polarization assembly at another face of the polarization beam splitter 375 to set the polarization state returned from the LCOS 380 and to fold the path for compact packaging. Modulated light directed via the polarization beam splitter 375 is then directed to a projection optic 388 for subsequent imaging.

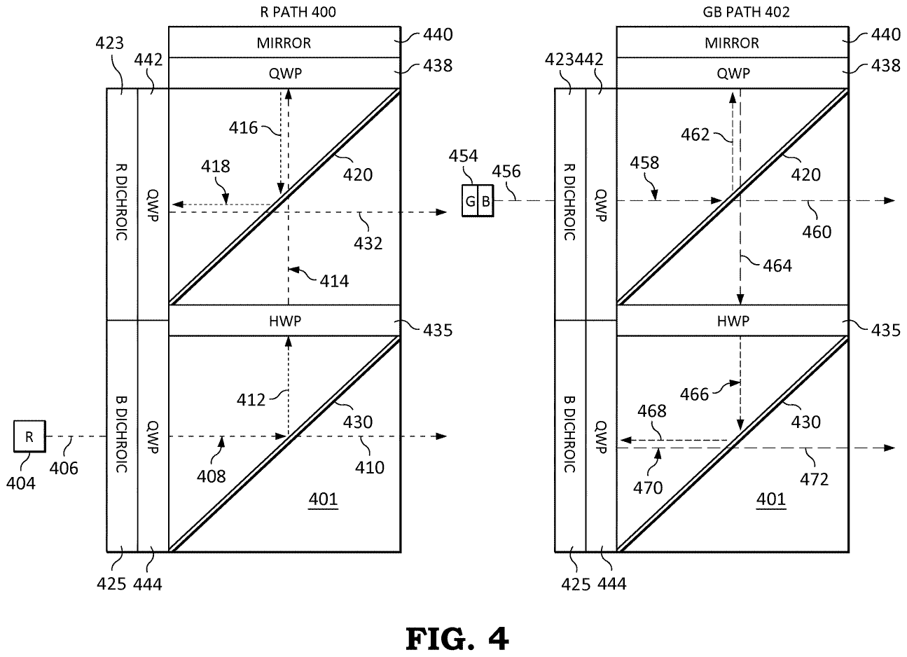

FIG. 4 illustrates an alternative optical pathway configuration for polarization recycling in an LCOS microprojector system, again featuring separate complementary panels 400, 402 for red (R) and green/blue (GB) light from respective LED sources, in accordance with some embodiments. In the depicted embodiment, a polarization-recycling prism 401 includes internal interfaces 420 and 430, wavelength-selective dichroic layers 423 and 425 disposed along its left-hand input face, quarter-wave plates (QWPs) 442, 438, and 444, a half-wave plate (HWP) 435 located between the internal interfaces, and an upper reflector 440 cooperating with QWP 438.

In a similar manner as that described with respect to QWPs 238, 242 of FIG. 2 above, the QWPs 442, 438, and 444 each provide approximately π/2 radians of retardance, such that a single pass through a QWP converts linear polarization to circular (or elliptical) polarization, with a double pass with reflection converting that linear polarization to an orthogonal linear state. In contrast, the HWP 435 provides approximately π radians of retardance between its fast and slow axes, and therefore rotates the orientation of linear polarization by twice the angle between the incident polarization and the HWP fast axis, while preserving linear polarization.

On the left-hand path 400, a red light source 404 emits a beam 406 that enters the polarization-recycling prism 401 through the GB-dichroic layer 425 and the QWP 444 and reaches position 408. At the lower internal polarization-recycling prism interface 430, the beam is split into a transmitted component 410, which proceeds to the right, and a reflected component 412, which is directed upward. The reflected component 412 passes through the HWP 435 and arrives at position 414 with its linear polarization rotated. From 414 the beam passes essentially unaffected through the upper interface 420 and propagates to the upper-right optical polarization assembly formed by QWP 438 and reflector 440, where it reflects and double-passes the QWP 438 to return with an orthogonal linear state; this returned beam is shown at 416. Reaching the upper internal interface 420 in the orthogonal (rejected) state, the beam 416 is reflected via that interface 420 leftward to position 418. The beam 418 then impinges on the upper-left optical polarization assembly that includes QWP 442 and the R-dichroic layer 423; this polarization assembly reflects the beam and returns it along path 432 with a polarization converted to the pass state of the upper interface 420. The beam 432 therefore passes through interface 420 and exits the polarization-recycling prism 401 to the right. In this manner, the directly transmitted component 410 from interface 430 co-propagates with the recycled/converted component 432, and the relative polarization rotations imparted by HWP 435 and the double-pass QWPs yield a common linear output state suitable for efficient downstream use, such as efficient illumination of a modulator.

On the right-hand green/blue (GB) panel 402, a GB source 454 emits GB beam 456 that enters the polarization-recycling prism 401 through the R-dichroic layer 423 and the QWP 442 to reach position 458. At the upper internal polarization-recycling prism interface 420, the beam at 458 is separated into a passed component 460 and a reflected component 462. The reflected component 462 is directed upward to the optical polarization assembly comprising QWP 438 and reflector 440, reflects and double-passes the QWP 438, and returns as beam 464 with a linear polarization converted to the pass state of interface 420. The beam 464 therefore transmits through interface 420 and traverses the HWP 435 (which rotates its linear polarization) to reach position 466. From 466, the beam encounters the lower internal interface 430 and is reflected leftward toward QWP 444 and the GB-dichroic layer 425, which together operate as a polarization assembly for wavelengths of the GB beam. The beam reflects from that polarization assembly and returns at position 470 with a polarization state converted to transmit at the interface 430; it therefore passes substantially unaffected through interface 430 and exits the polarization-recycling prism 401 to the right as beam 472. The passed component 460 co-propagates with the recycled/converted beam 472 to form the GB output.

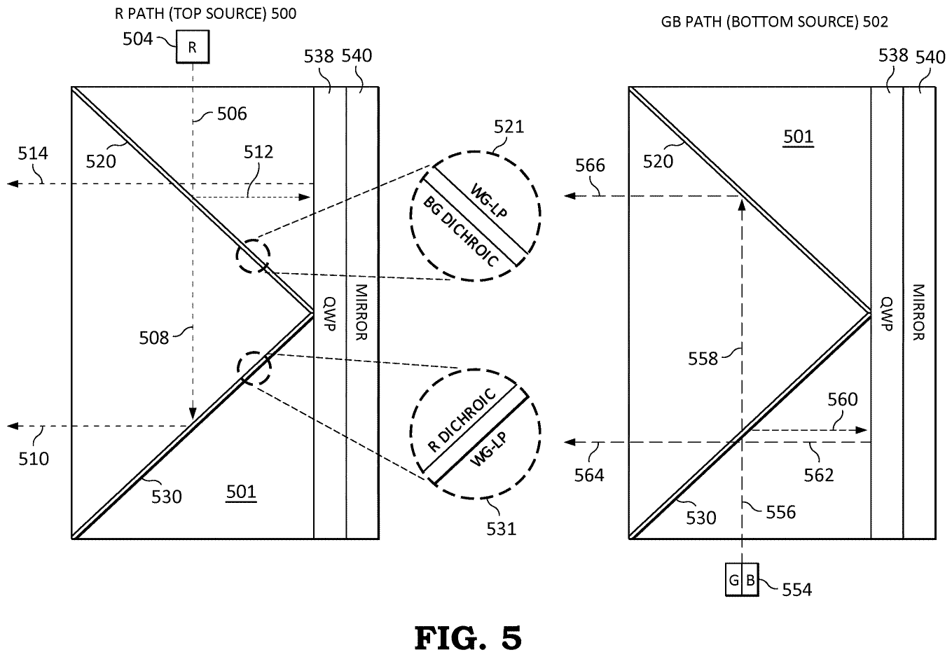

FIG. 5 illustrates complementary red and green/blue routing within another polarization-recycling prism 501, in accordance with some embodiments. In the depicted embodiment, the polarization-recycling prism 501 has internal polarization-recycling prism interfaces 520 and 530 (with coatings 521 and 531 that respectively operate in a similar manner as those of interfaces 221 and 231 of FIG. 2) and a polarization assembly formed by a quarter-wave plate (QWP) 538 adjacent to a reflector 540 along the right face. On the R path 500, a red source 504 emits a beam 506 into the polarization-recycling prism 501. At interface 520 the beam is divided: a first component 512 is reflected toward the QWP/reflector polarization assembly 538/540, double-passes the QWP 538, reflects from the reflector 540, and returns with a linear polarization converted to transmit at interface 520, exiting as beam 514. The complementary component 508 proceeds to the lower interface 530 and is reflected to form beam 510. In various embodiments, the recycled component 514 and the component 510 share a common linear polarization suitable for efficient downstream use.

On the GB path 502, a GB source 554 emits a beam 556 into the same polarization-recycling prism 501. At the lower interface 530 the beam is divided: a first component 560 is reflected toward the QWP/reflector polarization assembly 538/540, double-passes the QWP 538, reflects, and returns with a linear polarization converted to transmit at interface 530, exiting as beam 564. The complementary component 558 proceeds to the upper interface 520 and is reflected to form beam 566. As with the R path, the recycled component 564 and the component 566 emerge with a common linear polarization.

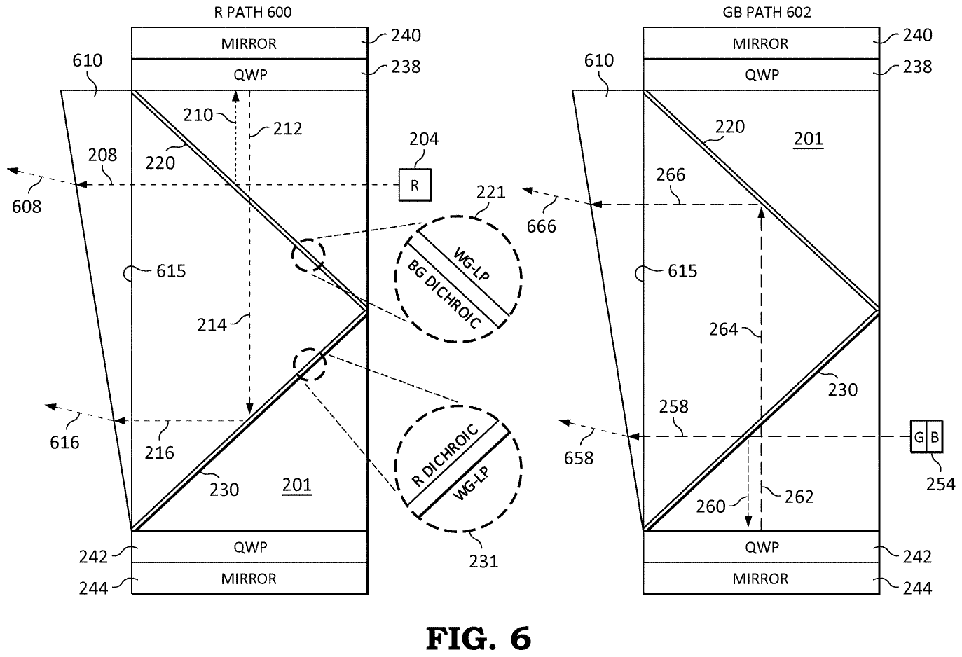

FIG. 6 illustrates an embodiment in which a wedge prism 610 is disposed adjacent to the output face 615 of the polarization-recycling prism 201. The internal routing, optical polarization assemblies 238/240 and 242/244, and coated interfaces 221 and 231 are as described for FIG. 2. For the R path 600, the beam components 208 and 216 emerging from the polarization-recycling prism 201 via output face 615 propagate through the wedge prism 610 and are refractively deflected to form redirected beams 608 and 616, respectively. On the GB path 602, the corresponding components 266 and 258 pass through the wedge prism 610 and are deflected to form redirected beams 666 and 658, respectively. In various embodiments, the wedge angle of the prism 610 is selected to fold the illumination path, align the exiting beams with a downstream pupil or optical axis, provide clearance from mechanical structures, or introduce a controlled separation between spectral channels.

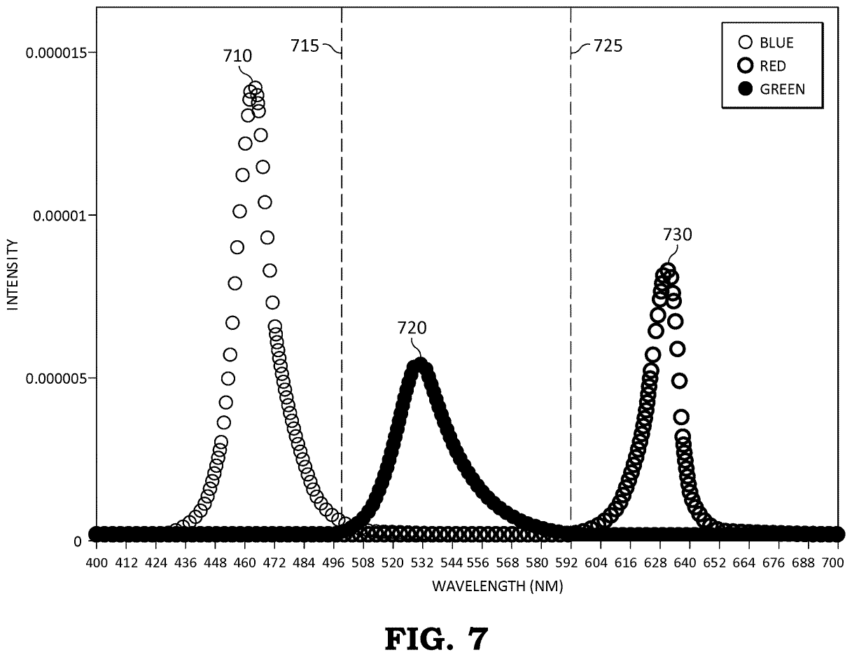

FIG. 7 illustrates a spectral graph depicting an intensity distribution across wavelengths for blue, green, and red LED segments in a projection system with polarization recycling, in accordance with some embodiments. The spectral graph shows distinct peaks 730, 720, 710 respectively corresponding to the emission spectra of each R, G, B color channel.

The horizontal axis of the spectral graph represents wavelength in nanometers (nm), ranging from approximately 400 nm to 700 nm, covering the visible light spectrum. The vertical axis represents the relative intensity of each color channel, with values scaled to highlight the distribution and separation between wavelengths.

The blue peak 710, centered around 450 nm, represents the blue LED emission. The green peak 720, centered around 530 nm, indicates the green LED emission, and the red peak 730, centered around 620 nm, represents the red LED emission. Vertical dashed lines 715 and 725 divide the primary wavelength ranges for each color, indicating transition zones between color channels that are managed by the dichroic coatings (e.g., interface coatings 241, 231, 521, 531) in the polarization recycling element (e.g., polarization-recycling prisms 201, 301, 401, 501).

In various embodiments, this type of spectral distribution supports efficient polarization recycling by enabling each LED segment to emit light within a narrow, targeted wavelength range. Dichroic coatings in embodiments of a projection system in accordance with techniques described herein selectively transmit or reflect light based on these wavelengths, enhancing color uniformity and brightness while maintaining compact optical paths suitable for AR displays.

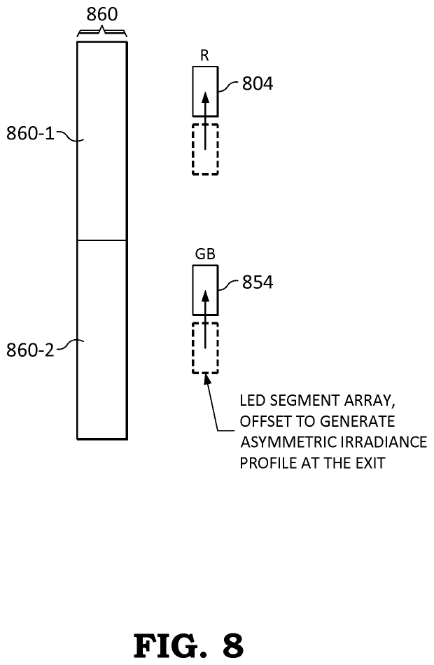

FIG. 8 illustrates an LED segment array and condenser lens array configuration designed to generate an asymmetric irradiance profile at the exit pupil of a projection system, in accordance with certain embodiments. The system includes a condenser lens array 860 having segments 860-1 and 860-2 (which in various embodiments may be implemented as Fresnel elements), respectively positioned to collimate light from LED segments including a red emitter 804 and a green/blue emitter 854. In the depicted embodiment, the LED segments 804, 854 are offset relative to the optical axes of the respective condenser segments 860-1 and 860-2. This offset causes the irradiance profile to be asymmetric at the exit pupil of the projection system. This asymmetry assists in matching the desired illumination pattern on the modulator, reducing artifacts and enhancing uniformity across the projected image.

In certain embodiments, specific LED array configurations (e.g., emitters 804 and 854) and condenser optics (e.g., segments 860-1 and 860-2) are utilized to enhance light efficiency and color uniformity in projection systems. Through customized LED placements, varied sub-LED configurations, and tailored geometric arrangements of the condenser lens array, such embodiments improve both irradiance profiles and étendue matching for improved optical performance.

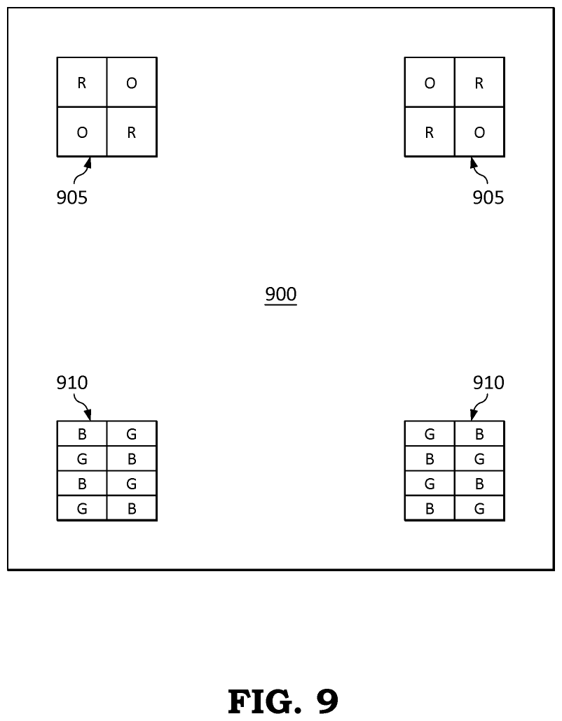

FIGS. 9, 10, and 11 illustrate non-limiting examples of specific LED array configurations, arranged to improve color mixing and achieve uniform light distribution across the LCOS panel in accordance with some embodiments.

FIG. 9 illustrates an example tile arrangement 900 for segmented emitters within an LED array. In the upper pair 905, red-emitting sub-LEDs are interleaved with an adjacent orange/red sub-band to promote local color mixing across each tile while preserving compact source étendue. In the lower pair 910, green and blue sub-LEDs are alternated in a checker pattern to balance the GB band locally at the condenser input. The left and right instances in each pair show mirrored placements suitable for opposing sides of a polarization-recycling prism, enabling symmetric coupling into the condenser lens array.

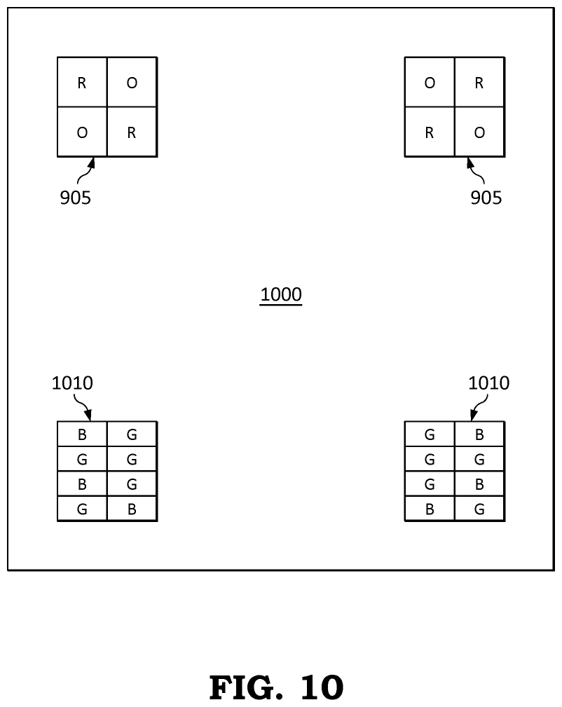

FIG. 10 depicts a further tile arrangement 1000 in which the same sub-LED types are repositioned to control segment-to-segment chromatic averaging. In the red tiles 905, the quadrant order is rotated relative to FIG. 9 so that, after relay through a condenser lens array, the projected sub-images overlap differently at the pupil to adjust the red channel's spatial weighting. In the GB tiles 1010, the relative positions of green and blue sub-LEDs are interchanged along one axis, such as to compensate for asymmetries while maintaining comparable overall étendue.

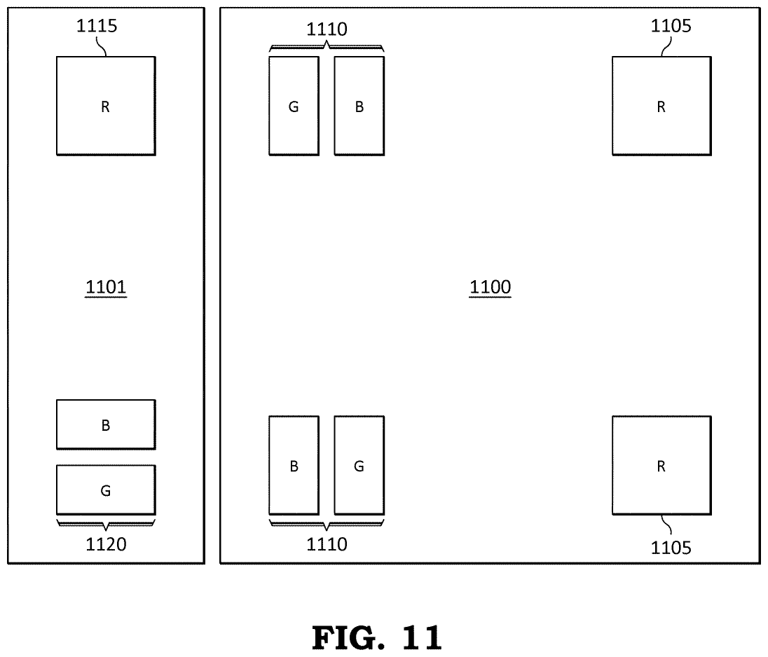

FIG. 11 shows segment groupings 1100 and 1101 utilized together. On the right, red sources 1105 are arranged as vertically separated bars to provide two independent coupling positions that can equalize irradiance across the exit pupil, with a GB grouping 1110 that arranges green and blue bars in alternating order to enhance local GB mixing along the long axis of the condenser element. On the left, an alternate GB configuration 1120 is paired with a single-tile red emitter 1115.

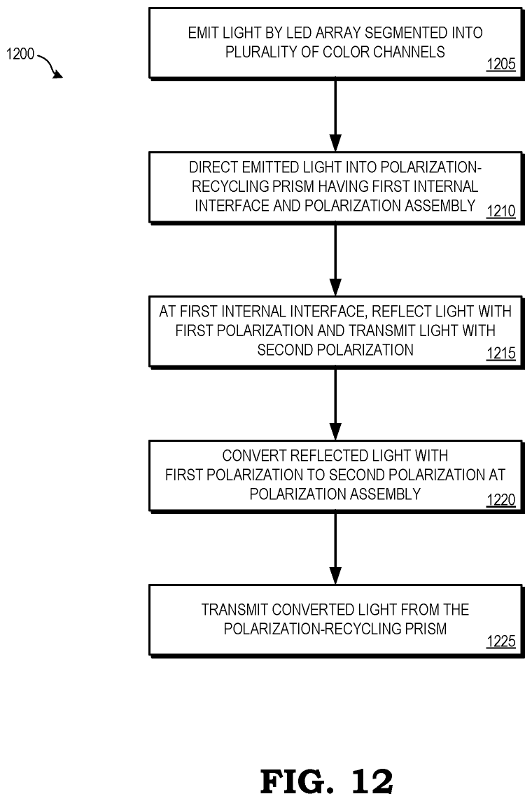

FIG. 12 is an operational flow diagram illustrating a method 1200 of operating an illumination module configured for polarization recycling, in accordance with some embodiments. At 1205, light is emitted by an LED array segmented into a plurality of color channels, each channel emitting at one or more wavelengths. At 1210, the emitted light is directed into a polarization-recycling prism having a first internal interface and an associated polarization assembly disposed within or adjacent to the prism. At 1215, the first internal interface separates the incident light by polarization, reflecting light having a first polarization state and transmitting light having a second polarization state along the prism. At 1220, the polarization assembly converts at least a portion of the reflected light from the first polarization state to the second polarization state—for example, via a double pass through a quarter-wave plate with reflection from a reflector, or by other retarder configurations described elsewhere herein. At 1225, the converted light in the second polarization state is transmitted from the polarization-recycling prism for delivery to downstream optics.

In various embodiments, the operations of FIG. 12 are performed continuously for each color channel of the LED array, and may be reordered or combined depending on optical layout while maintaining the functional sequence of polarization separation, conversion, and transmission generally described with respect to operations 1215, 1220, and 1225.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A system comprising:
a light-emitting diode (LED) array segmented into a plurality of color channels, each color channel configured to emit light at one or more wavelengths; and
a polarization-recycling prism comprising:
a first internal interface configured to reflect light having a first polarization state and transmit light having a second polarization state; and
a polarization assembly disposed within or adjacent to the prism and configured to convert light of the first polarization state to the second polarization state.

2. The system of claim 1, wherein the polarization-recycling prism comprises a plurality of dichroic coatings disposed on one or more internal surfaces of the prism.

3. The system of claim 1, further comprising a condenser lens array coupled to the LED array and comprising a plurality of condenser lenses, each condenser lens configured to collimate light emitted from a corresponding color channel of the LED array.

4. The system of claim 3, wherein the LED array is laterally offset relative to the condenser lens array to generate an asymmetric irradiance profile at an exit pupil of the system.

5. The system of claim 1, wherein the polarization assembly comprises a quarter-wave plate and one or more reflectors.

6. The system of claim 1, further comprising a display panel, and wherein the polarization-recycling prism is configured to transmit light having the second polarization state toward the display panel.

7. The system of claim 6, wherein the polarization assembly comprises a half-wave plate positioned to rotate a linear polarization state of light directed toward the display panel.

8. The system of claim 1, wherein the polarization-recycling prism further comprises a second internal interface, and wherein dichroic coatings on the first and second internal interfaces are configured to provide complementary spectral routing for a first wavelength band and a second wavelength band.

9. The system of claim 1, wherein the LED array comprises spatially separated light sources positioned on substantially opposing sides of the polarization-recycling prism to inject light through respective input faces of the prism.

10. The system of claim 1, wherein the polarization assembly comprises a quarter-wave plate disposed between the first internal interface and a reflector.

11. The system of claim 1, further comprising an optical wedge coupled to an exit face of the polarization-recycling prism and configured to redirect light transmitted from the polarization-recycling prism.

12. A method comprising:
emitting light at one or more wavelengths by a light-emitting diode (LED) array segmented into a plurality of color channels;
directing the emitted light into a polarization-recycling prism having a first internal interface and a polarization assembly disposed within or adjacent to the polarization-recycling prism;
at the first internal interface, reflecting light having a first polarization state and transmitting light having a second polarization state;
converting, by the polarization assembly, the reflected light of the first polarization state to the second polarization state; and
transmitting the converted light from the polarization-recycling prism.

13. The method of claim 12, further comprising routing the emitted light within the polarization-recycling prism using dichroic coatings disposed on one or more internal surfaces of the prism.

14. The method of claim 12, further comprising collimating the emitted light with a condenser lens array optically coupled to the LED array, the condenser lens array comprising a plurality of condenser lenses that are each configured to collimate light from a corresponding color channel of the LED array.

15. The method of claim 14, further comprising laterally offsetting the LED array relative to the condenser lens array to generate an asymmetric irradiance profile at an exit pupil.

16. The method of claim 12, wherein converting the reflected light comprises reflecting the light from one or more reflectors and passing the light through one or more of a group that includes a quarter-wave plate or a half-wave plate.

17. The method of claim 12, further comprising transmitting light having the second polarization state from the polarization-recycling prism toward a display panel.

18. The method of claim 12, further comprising, within the polarization-recycling prism, providing complementary spectral routing for a first wavelength band and a second wavelength band using dichroic coatings on the first internal interface and a second internal interface.

19. An optical apparatus, comprising:
a prism having a first internal interface configured to reflect light having a first polarization state and transmit light having a second polarization state; and
a polarization assembly disposed within or adjacent to the prism and configured to convert light of the first polarization state to the second polarization state.

20. The optical apparatus of claim 19, comprising a plurality of dichroic coatings disposed on one or more internal surfaces of the optical apparatus.
